(19) United States
(12) Patent Application Publication
(10) Pub. No.: US 2018/0304214 A1
(43) Pub. Date: Oct. 25, 2018

(54) Condensate Prevention Hood

(71) Applicant: Eppendorf AG, Hamburg (DE)

(72) Inventors: Matthias Baumgartner, Hamburg (DE); Gerrit Walter, Hamburg (DE); Florian Dürr, Hamburg (DE); Janine Röhrs, Hamburg (DE); Arne Schafrinski, Bad Oldesloe (DE)

(21) Appl. No.: 15/921,548

(22) Filed: Mar. 14, 2018

Related U.S. Application Data
(63) Continuation of application No. 13/643,948, filed on Jun. 26, 2013, now abandoned.

(30) Foreign Application Priority Data
May 3, 2010 (DE) 102010019232.5

(51) Int. Cl. B01F 9/00; H05B 6/10; H05B 6/06; B23P 19/00; B01L 7/00

(52) U.S. Cl. CPC B01F 9/0016; H05B 6/10; H05B 6/06; B23P 19/00; B01L 2300/1805; B01L 7/00; Y10T 29/49826

(57) ABSTRACT

The invention relates to a device for controlling the temperature of laboratory vessels, comprising at least one vessel receptacle for receiving the laboratory vessels, at least one removably designed peripheral unit, and a base unit which has a temperature control device and a mounting for placing the at least one removable peripheral unit in a defined position, characterised in that the base unit and the at least one peripheral unit each have at least one coupling element, with said elements, when the peripheral unit is placed onto the base unit in the defined position, forming at least one releasable coupled pair by which the electrical power and/or at least one signal can be transmitted.

The present invention relates to a device for controlling the temperature of laboratory vessels, comprising at least one vessel receptacle for receiving the laboratory vessels, at least one removably designed peripheral unit, and a base unit which has a temperature control device and a mounting for placing the at least one removable peripheral unit in a defined position, as well as also the peripheral unit for this device.

Devices for controlling the temperature of laboratory vessels, in particular also ones which, in addition to controlling the temperature, also still put the laboratory vessels into a mixing motion (temperature-regulated mixers) are well known. The previously known devices have holders, which accommodate laboratory vessels, or groups of laboratory vessels. Laboratory vessels are usually standardised. For example, laboratory vessels exist which can hold 0.2 ml, 0.5 ml, 1.5 ml or 2.0 ml. Furthermore, there are, for example, Cryo vessels, Falcon tubes (for example, 15 ml or 50 ml), glass vials and beakers, microtitre plates with, for instance, 96 or 384 vessels (MTP), deep well plates (DWP) or PCR plates with, for example, 96 vessels (wells). This list is not conclusive, does, however, indicate what a large variety of laboratory vessels and vessel combinations exist, for which the mixers should be suitable.

The holders for the laboratory vessels or vessel combinations on the devices already mentioned may be exchangeable (so-called “exchangeable blocks”). Because the exchangeable blocks are mostly designed in such a way that the single vessels are inserted into them from above, a circular translational recurrent mixing motion has become established, by way of preference, for the well-known mixers, which largely occurs on a horizontal plane, and can also be described as an orbital motion. For this purpose, the well-known mixers are usually equipped with an eccentric drive, which is preferably driven by an electric motor. The eccentric drive is linked to a plate, which is, in the specialist jargon, also termed a “table”. The plate serves as a retainer for a vessel holding device, which may be constructed so that it is exchangeable, such as in the form of a so-called metallic exchangeable block, or otherwise permanently installed, i.e. not exchangeable. Usually the vessel holding device is firmly screwed to the plate. The eccentric drive sets the plate with the vessel holding device into the circular orbital motion. Usually such mixers are driven with a rotational frequency of 200 rpm to 3,000 rpm, however, in some cases, rotational frequencies range from 100 rpm to 10,000 rpm. The frequency can usually be adjusted.

The device for controlling the temperature of laboratory vessels can, as is generally known, provide, for an exchangeable block, a retainer, on the top of which a source of heat or heat sink of the temperature control device heats a contact surface, which is in contact with the bottom of the exchangeable block, allowing for good thermal conduction. This contact surface on the retainer is thus in contact with the exchangeable block mounted thereon, allowing for good thermal conduction.

Exchangeable blocks usually mostly consist of materials with good thermal conductivity, such as metals, in particular aluminium or silver, wherein the block may be of a solid construction or may have an eroded structure, which, for the purposes of weight reduction, only comes equipped with structures for accommodating samples and a good heat transmission from the underside of the exchangeable block to the vessels. In order to produce the thermally conductive contact with the temperature-regulated contact surface of the retainer, such exchangeable blocks are known to be screwed down onto the retainer. The screws can be loosened relatively easily with the help of a tool, such as a screwdriver, so that the exchangeable block can be exchanged, for example, for an exchangeable block for laboratory vessels of a different size.

In particular for the devices to have a temperature control function, it is known, in order to reduce condensate in the vessels, to cover over a space around the vessel holding device with a hood, and thus enclose it together with the housing of the temperature control device and/or the vessel holding device so that it is, to a certain extent, thermally insulated. This has the effect that not only the vessels in the retainer are heated by the temperature control device, but also their direct environment, without there being any exchange with the greater environment. This reduces the condensation of any liquid possibly vaporised in the vessels on the exposed vessel walls (which are cooler without the hood)—especially on the lid of the vessel—due to the heating. This is an effect which can, for example, be observed on cold window panes, on which condensed water resulting from warmer indoor air precipitates.

Moreover, for such devices with hoods it is known for such hoods to be heated themselves, by means of heating elements in the hood, e.g. heating foils. The power supply of such heating elements in the known hoods is provided either via a detachable galvanic connection to the base unit with a temperature control function (power supply provided by device) or via a centralised external electrical power source, such as an electrical socket. What the two options have in common is that the hood has a plug-like galvanic contact, which needs to be taken up in the user's hand and actively plugged into the actual device or external electrical power source.

The object forming the basis for the present invention is to make a device for handling the contents of laboratory vessels simpler and ensure it can be handled in such a way that it is safe to operate.

According to the invention, this object is solved by means of a device having the features of claim 1 and a peripheral unit having the features of claim 17. Preferred embodiments are cited in the sub-claims.

It has been discovered that the device designed according to the invention for controlling the temperature of laboratory vessels consisting of a base unit with a temperature control device and a holder for the peripheral unit, as well as at least one peripheral unit and vessel receptacles, can be handled more easily and in a manner that is safe to operate. Decisive for its being more easily manageable and having greater operational reliability is the property of the device that, when the peripheral unit is placed on the base unit, a detachable coupled pair is automatically formed, through which the electric power and/or at least a signal can be transmitted.

The term “automatically” means, in this context, that the coupled pair is formed without the respective coupling elements having to be taken up by the operator in his or her hand and inserted into one another. Thus, the operator places the peripheral unit on a holder on the base unit, without having to personally come into contact with the coupling elements. For the operator in the laboratory area, this has the advantage that the risk of accidentally coming into contact with hot surfaces of the temperature control devices placed on the base unit is reduced. Furthermore, the operator does not touch any live parts. As the operator working in the laboratory, also with biological or chemical substances which are potentially hazardous to health, does, overall, have to come into contact with fewer parts of the device, a reduction in the risk of contamination posed by the device results from the latter. Fewer parts of the device need to be cleaned or respectively decontaminated. Moreover, it is, on the whole, easier to clean the device, as no parts which are difficult to access or sensitive need to be cleaned. The device designed according to the invention is thus altogether safer to operate and easier to handle.

The automatic formation of a coupled pair between the base unit and the peripheral unit, through which, in particular, also a signal can be transmitted from the peripheral unit to the base unit and vice versa, i.e. from the base unit to the peripheral unit, allows for a very rapid exchange of information between such parts of the device. This is advantageous in two respects. Firstly, it simplifies the manufacture of the device, as the base unit and the peripheral unit can be manufactured separately, in regard to which device-specific information can be stored on the respective device in a storage medium, preferably an integrated circuit, and in particular preferably a memory chip. Such device-specific information is, for example in the case of a thermally conductive metallic exchangeable block, of serial numbers, adjustment values of temperature detectors, maximum mixing frequencies and block-specific control parameters for the temperature control, which are located in the exchangeable block. Block-specific control parameters are expedient in order to—in spite of different block dimensions—maintain an optimum transient response (no overshooting or temperature control ramps that are too low). Serial numbers can be scanned by the base unit, and thus make it possible to clearly document the test. For a hood which has the function of avoiding condensate, typical device information is, for example, serial numbers, adjustment values of temperature sensors and control parameters for controlling the temperature. The typical device information stored in the storage medium on the peripheral unit, e.g. the adjustment value of a temperature sensor, is to be transmitted as a signal via the coupled pair which automatically forms when the peripheral unit is placed on the base unit for the first time, so that the device according to the invention is ready for operation in the assembled state without any further adjustment. Consequently, the individual steps which are otherwise customary in the manufacturing process, in particular the thermal reconciliation in the assembled state which is otherwise usually carried out, can be dispensed with. Furthermore, any blocks newly developed at a later date can be operated on the basic device without further adjustments having to be made (such as software updates to the base unit). For the laboratory operator, the rapid exchange of information through a signal being transmitted by means of the coupled pair which is automatically formed between the peripheral unit and the base unit is likewise advantageous. Usually there are various different peripheral units, in particular various exchangeable blocks, for a base unit, which the operator all has in stock. Judging by their outward appearance, such exchangeable blocks cannot easily be distinguished from one another, although they are only suitable for particular applications. In the case of the device according to the invention, such typical device information and/or user-specific parameters in regard to particular applications on the respective device are stored in a storage medium, preferably an integrated circuit, and, particularly preferred, on a memory chip. When the peripheral unit is placed on the base unit, the signal is transmitted from the peripheral unit to the base unit through the coupled pair which automatically forms and can be dissolved again, and the operator receives an optical or acoustic signal in regard to the peripheral unit. Information is transmitted via the signal. This way, it can, for example, be shown on a display on the base unit—or respectively be announced by a loudspeaker on the base unit—that the peripheral unit is only suitable for certain applications. The device according to the invention preferably has a display on which the information is displayed to the operator. Examples of operator-specific parameters which can be stored on the storage medium are particular temperature control ranges, e.g. “Only use block at temperatures between 15° C. and 50° C.”, limitations in regard to substances, such as “Only use block for biological substances”, revolution speed restrictions, such as “Only use block up to a maximum number of revolutions of 2000 rpm”. Furthermore, boundary parameters relating to safety are laid down, such as the maximum number of revolutions, in the various different blocks. This prevents too high mixing frequencies from being set, which, in the case of heavier and/or larger blocks, would lead to imbalance and vibrations of the base unit; imbalance and vibrations lead to the entire device possibly being moved away from the work surface, and thus posing a risk in regard to the samples, the device and the operator. The device according to the invention is simpler and safer to operate through this property, as, when placing the peripheral unit on the base unit, in particular when placing it on an exchangeable block, the operator receives information regarding the suitability of the peripheral unit for particular applications. This way, any erroneous applications, which may damage samples, or respectively applications which may damage the device (either the base unit or the peripheral unit), are avoided.

From what has been said above, in particular for the peripheral unit the advantage emerges that it will have an extended useful life, as erroneous applications are avoided.

The invention therefore relates to:

1. a device for controlling the temperature of laboratory vessels with
at least one vessel receptacle for receiving the laboratory vessels
at least one removably designed peripheral unit, and with
a base unit having a temperature control device and a mount for placing the at least one removable peripheral unit in a defined position, characterised in that the base unit and the at least one peripheral unit each have at least one coupling element, which, when the peripheral unit is placed on the base unit in the defined position, form at least one releasable coupled pair, through which the electric power and/or at least one signal can be transmitted:

2. the peripheral unit for use in said device;

3. use of the device or respectively the peripheral unit for biological, biochemical, molecular biological and/or chemical applications in the laboratory; and

4. a method of manufacturing such a device designed according to the invention and/or the peripheral unit designed according to the invention.

The following terms are defined below in the case of the present invention:

“Controlling the temperature”: in the sense of the present invention this means actively adjusting the temperature of an item or a liquid. It includes both heating and cooling. The term “controlling the temperature” in particular means setting the temperature to a reference value by adjusting the temperature in the vessel holding device, in particular in the vessel receptacle, and thus in the sample.

“Laboratory vessels” means one or a plurality of containers usually found in a laboratory for receiving samples. The samples concern substances, in particular liquids, such as solutions, mixtures, suspensions, dispersions of blood, etc., or solids. The term in particular relates to containers for holding small volumes (micro-volumes), such as 0.1 ml, 0.2 ml or 0.5 ml, which are usually subsumed under the name “Eppendorf vials”. Moreover, such vessels as can hold greater volumes (e.g. 1-100 ml), which are usually used in a laboratory, are also subsumed under this term. For instance, Falcon tubes, glass vials and beakers are subsumed under this term. Plates, in which a large number of individual vessels, in particular 12, 96, 384, 1536 individual vessels, are combined, such as microtitre plates (MTP), deep well plates (DWP), PCR plates or cell culture plates, are also subsumed under this term. “Laboratory vessels”, within the meaning of the present invention, means, in particular, the above-mentioned laboratory vessels filled with a sample.

“Vessel receptacle” means a groove or respectively recess in a vessel holding device (receiving device) which is usually designed as a quadrilateral block, and is therefore also described as a vessel block. The groove is designed in such a way that a laboratory vessel can be received; it is dimensioned in such a way that the laboratory vessel comes into contact with the base and lateral walls of the vessel receptacle, and thus a thermally conductive contact arises between the vessel receptacle and the laboratory vessel. A vessel block can have a vessel receptacle or a plurality of vessel receptacles. The vessel block is preferably manufactured from a very thermally conductive material, i.e. X is approx. 200. The vessel block itself is in thermally conductive contact with that of a temperature control device. The vessel block can be permanently installed (not intended to be removed by the operator) or designed to be completely removable (removable by the operator). The vessel block is preferably a so-called exchangeable block, which can be completely removed. If the device according to the invention is designed to control the temperature as an immovable device, i.e. purely as a thermostat, the vessel block is not moved. Should the device according to the invention be designed to control the temperature as a mixer (temperature-controlling mixer), the vessel block is put into a mixing motion via the drive.

“Exchangeable block” means a particular design of a vessel holding device (vessel block). The vessel block is designed as a removable peripheral unit. Exchangeable blocks usually largely consist of very thermally conductive materials, such as metals, in particular aluminium or silver, wherein the exchangeable block may be of a solid design, or, in order to make the weight lighter, may have an eroded structure. An exchangeable block has the vessel receptacle(s) on its upper surface. On its underside, it is designed flat, except for the ledge areas, which serve to attach it to the base unit. This ensures thermally conductive contact over an optimally large surface with the temperature-controlled contact surface of the base unit. The ledge areas of the exchangeable block serve to fix the exchangeable block to the mount of the base unit. The mount of the base unit and the lateral regions of the exchangeable block may interact with one another another in a form fit and/or a force fit manner. For example, elements which undercut one another, spring elements or screws can provide a means of fastening. What all types of fastening have in common is that they can be easily loosened by the operator. Thus, it is possible for the operator to remove an exchangeable block from the base unit and place a different exchangeable block on it. The various different exchangeable blocks can, for example, be distinguished by type and/or by the number of their vessel receptacles. An exchangeable block is an embodiment of a removably designed peripheral unit. If the device according to the invention aimed at controlling the temperature is designed as an immovable device, i.e. purely as a thermostat, the removable block is not moved. Should the device according to the invention aimed at controlling the temperature be designed as a mixer (temperature-controlling mixer), the removable block is put into a mixing motion via the drive.

“Removably designed peripheral unit” means a component of the complete device designed according to the invention (device for controlling the temperature) which is distinguished by being entirely separable from the base unit. The peripheral unit is placed on the top of the base unit. The peripheral unit has elements requiring electrical energy, such as detectors, an integrated circuit (=IC) and/or a heating element, such as a heating foil. Detectors and circuit are also subsumed under the heading “sensor system”. The latter in particular features at least one temperature sensor and at least one memory chip, especially an EEPROM. The sensor system of a peripheral unit requires an electric power of between 0.1 and 10 watts. Electrical power consuming devices, such as a heating foil, require an output of between 50 and 500 watts. The peripheral unit requiring electrical energy can be connected to the base unit without any wiring. The peripheral unit has at least one coupling element, which forms a releasable coupled pair together with a counterpart in the base unit, via which the electric power and/or a signal can be transmitted. Preferably, the removably designed peripheral unit concerns an exchangeable block and/or a hood for avoiding condensate. The complete device can only be equipped with one removably designed peripheral unit. This embodiment can be designed as follows: 1. A device designed according to the invention having a vessel receptacle in a permanently installed vessel block and a hood for avoiding condensate as a peripheral unit, wherein the vessel block is fixed to the base unit; 2. A device designed according to the invention having a vessel receptacle in an exchangeable block. The complete device can also be equipped with a plurality of removably designed peripheral units, in particular with two peripheral units. This embodiment can be designed as follows: 1. A device according to the invention having a vessel receptacle in an exchangeable block as a first peripheral unit and a hood for avoiding condensate as a second peripheral unit; 2. A device designed according to the invention having a vessel receptacle in a first exchangeable block and a vessel receptacle in a second exchangeable block. The complete device can also be equipped with three removably designed peripheral units. This embodiment can be designed as follows: A device according to the invention having a vessel receptacle in a first exchangeable block and a vessel receptacle in a second exchangeable block, and a hood for avoiding condensate covering both exchangeable blocks as a third peripheral unit. The complete device can also be equipped with four removably designed peripheral units. This embodiment can be designed as follows: A device designed according to the invention having a vessel receptacle in a first exchangeable block and a vessel receptacle in a second exchangeable block, and respective separate hoods for avoiding condensate covering each individual exchangeable block as third and fourth peripheral units. Should the complete device designed according to the invention be designed as a heated mixer, the peripheral unit having the vessel receptacle is likewise put into a mixing motion. Should the peripheral unit be a hood for avoiding condensate, it is not put into a mixing motion, i.e. the hood for avoiding condensate remains motionless during the mixing process. This is advantageous, as it extends the useful life of the sensitive detectors.

“Base unit” means the component of the complete device that is responsible for the entire electrical power supply of the complete device and which comprises the operator environment and the control elements. If the complete device according to the invention is aimed at controlling the temperature of a mixer (temperature-controlled mixer), the drive is likewise to be found in the base unit. The base unit is connected to an external electrical power source or itself includes a power source. A device for controlling the temperature can be found on the top of the base unit, as well as a mount for placing the peripheral unit and fixing it in a defined position. The temperature control device serves to indirectly control the temperature of the laboratory vessels to be found in a vessel receptacle in a vessel block. The vessel block is in direct contact with the temperature control device located on the top of the base unit, so that the temperature control device directly keeps the vessel block at the desired temperature.

“Holder” means one or more fastening elements on the base unit which serve to removably fix the peripheral unit to the base unit. The holder is designed in such a way that at least one peripheral unit can be placed on the base unit. If the complete device according to the invention is constructed as a mixer (heated mixer), which includes both an exchangeable block and a hood for avoiding condensate, a first fastening element can be found on a moveable component of the base unit. The peripheral unit having the vessel receptacle, in particular an exchangeable block, is placed on top of this first fastening element, in order to likewise put the exchangeable block with the vessel receptacle into a mixing motion. A second fastening element is to be found in an unmoved area of the base unit, i.e. an area which is not moved by the drive. The hood for avoiding condensate is placed on top of this second fastening element, which does not take part in the mixing motion. “Defined position” or the synonymous term “intended position”, designate the only possible correct positioning of the peripheral unit on top of the base unit. The positioning is correct as long as the respective coupling elements on the peripheral unit and the base unit form a fully functional releasable coupled pair, via which at least one signal and/or electric power can be transmitted. Whether the peripheral unit is placed in the defined position can be discerned by the signal transmission which immediately occurs, which makes it possible for the base unit to identify the peripheral unit, and which is displayed to the operator or a display on the base unit.

“Coupling element”, as a generic term, describes various technical elements which automatically make both a signal and a transmission of electrical energy possible between the peripheral unit and the base unit. In particular, a coupling element is an optical coupling element. An optical coupling element is also termed an optical coupler, and enables the signal and power to be transmitted optically. Optical couplers are in particular an LED, an infra-red LED and as counterpart to a photoreceiver, a photodiode, a phototransistor or a light-dependent resistor (LDR). The complete device according to the invention or respectively the peripheral unit according to the invention preferably have optical couplers for signal transmission.

An inductive coupling element, in particular a coil, likewise falls under the term “coupling element”. The two interacting coils in the base unit (primary coil) and peripheral unit (secondary coil) work as loosely coupled transformer. A coil has an “E” ferrite core. Between the two coils in the base unit (primary coil) and peripheral unit (secondary coil) there is an air gap of approx. 2 mm. The air gap to be spanned greatly affects the dimensions of the distances between the ferrite flanks. In the case of a very small air gap, the distance of the flanks is likewise small, for example in the case of a 4 mm core (cup core) a 1 mm flank distance is sufficient to span a distance of approx. 0.5 to 1 mm. In the case of a greater distance, the flank distance selected also needs to be greater (e.g. approx. 3-4 mm). Only in this way is it ensured that the magnetic field lines can diffuse further into the space, and that thus an adequate magnetic interaction occurs in the secondary ferrite coil unit to also receive a sufficient degree of efficiency of the power transmission.

A capacitive coupling element likewise falls under the term “coupling element”. A capacitive coupling element consists of a capacitor. A galvanic coupling element likewise falls under the term “coupling element”. A galvanic coupling element within the meaning of this invention is a spring-loaded contact (spring contact). An electrically conductive connection (electrical line connection) automatically adjusts itself in the base unit and in the peripheral unit via the respective spring contact.

“Releasable coupled pair” designates the fusion of a respective coupling element (first coupling element) in the base unit with its counterpart (second coupling element) in the peripheral unit, which is automatically adjusted if the peripheral unit is placed on top of the base unit in the defined position. When removing the peripheral unit from the base unit, the coupling elements become spatially separated from one another again, and the coupling is dissolved (releasable). The term “fusion” is, in this context, a connecting fusion if the coupling element concerns a galvanic coupling element. In the case of any other coupling elements (optical, inductive, capacitive) which form a coupled pair, the fusion is contact-free (without the components touching one another). The coupling elements are only to be found in spatial proximity, and are separated by an air gap. The air gap is preferably approx. 2 mm wide.

“The ability of electric power to be transmitted” within the meaning of this application means that electric power is coupled into a transmission link, and that electric power is available again at the end of the transmission link. Meanwhile, it can be transformed into any other forms of energy (e.g. magnetic or electrical fields, light), e.g. between base unit and peripheral unit, and subsequently be converted back again.

“Signal” within the meaning of this invention is information which is conveyed from a sensor and/or an IC (in particular an EEPROM) and/or a control unit to a receiver. Preferably, the signal concerns a measurement or state detected on the peripheral unit.

“Galvanically separated from one another” describes the lack of a conductive connection. Preferably, an air gap ensures that there is a lack of a conductive connection. A particular preference is an air gap that is 2 mm wide. In the embodiments of the device according to the invention with optical coupling elements, inductive and/or capacitive coupling elements, the base unit and the peripheral unit are also galvanically separated from one another in the merged state, i.e. the state that is ready for operation.

“Integrated circuit (IC)”: is an electronic component with circuitry. This is in particular a microchip, preferably an EEPROM.

“Galvanic contact element”, within the meaning of this invention, is an element consisting of conductive material through which electric power flows. A galvanic contact element in particular serves to transmit electric power from the base unit to the peripheral unit. In particular, the base unit and the hood for avoiding condensate each have a galvanic contact element, and the latter, when the hood for avoiding condensate is placed on top of the base unit, together form a detachable conductive contact. In the case of an embodiment according to the invention, the galvanic contact element on the base unit is a positioning mandrel (also called a positioning mandrel or mandrel) fixing an electrically conductive screw, which is connected to a power source to the top of the base unit. On the peripheral unit, the galvanic contact element is an annular spring, which sits in a groove of a jack. Should the mandrel or respectively mandrel of the base unit be inserted into the jack of the hood for avoiding condensate when placing the hood for avoiding condensate on top of the base unit, an electrically conductive contact is produced. The electricity is passed on from the jack with an annular spring on the hood for avoiding condensate via a cable to a heating foil or another heating element.

“Electrical power consuming devices” within the meaning of this invention are electronic components which consume between 50 and 500 watts of power. In particular those electronic components which consume between 50 and 300 watts of power, and, particularly preferred, those which consume between 100 and 200 watts of power. An embodiment of an electric power consuming device according to the invention is a heating element, in particular a heating foil, in the hood for avoiding condensate. An output of 160 watts is directed on this heating element.

“Hood for avoiding condensate” within the meaning of this invention is a hood which, together with the walls of the base unit and/or the vessel block, envelops a space around the vessel holding device in which the laboratory vessels are to be found. The hood, with the ceiling above and four lateral walls drawn down from the ceiling above, comprises thermally insulated materials in the walls and the ceiling. Moreover, the hood has, on its ceiling, a heating element, in particular a heating foil. The hood has a thermally insulating effect. The hood, furthermore, comprises at least one temperature sensor and/or at least one IC, in particular an EEPROM. The hood for avoiding condensate is an embodiment of the peripheral unit according to the invention, and has at least one coupling element, which, when the hood is placed on top of the base unit, forms a releasable coupled pair with its counterpart in the base unit. The hood according to the invention remains motionless in the case of all embodiments, i.e. it does not participate in the mixing motion.

“Form-fit”, within the meaning of this invention, is a connection when the transmission of force is exerted via form elements. The geometric design of the components prevents them from being separated.

“Force-fit”, within the meaning of this invention, is a connection when friction forces are generated on the contact surfaces through pre-tensioning forces or normal forces. Such friction forces prevent the components from being separated.

“Connecting elements” within the meaning of this invention solely serve the purpose of mechanical joining.

The device according to the invention has at least one vessel receptacle for receiving the laboratory vessels, at least one removable peripheral unit, and at least one holder which is designed to receive said at least one removable peripheral unit in a particular position on the base unit. The temperature control device consisting of at least one temperature control element (e.g. resistive or ceramic heating elements or Peltier elements) is preferably placed underneath said at least one vessel receptacle.

According to the invention, the base unit and said at least one peripheral unit each have a coupling element, and said coupling elements work together in pairs, as at least one releasable coupled pair, through which electric power and/or at least one signal can be transmitted if the peripheral unit is located in the particular position (defined position) on the base unit. Said at least one coupling preferably functions without an electrically conductive materials contact, i.e., in spite of galvanic separation, for example optically and/or inductively and/or capacitively. Out of said at least one coupled pair according to the invention, at least one, however, can also function as galvanically conductive. The signals transmitted are preferably light and/or electrical voltage signals. In the case of multiple coupled pairs according to the invention, the active principles mentioned can be combined as desired. Non-galvanic coupled pairs have the advantage that no liquid samples spilled can come into contact with electrically conductive components. Thus, potential short circuits and corrosion damage are avoided.

At least one coupling element is preferably an LED, in particular an infra-red LED, which works in combination with at least one coupling element in the form of a photodiode, a photoreceiver, a phototransistor or a light-dependent resistor (LDR) as an optoelectronic coupling. This type of coupling functions in a single direction. Depending upon the direction of transmission, the coupling elements are consequently located in either the base unit or the peripheral unit. This type of coupling is preferably utilised for signal transmission.

At least two coupling elements can, however, also be coils (or capacitors), which interact with one another inductively as a coupling (or as capacitors, capacitively), or spring-loaded galvanically conductive contacts. Through a single pair of such coupling elements, signals and/or power can be electrically transmitted in multiple channels. By utilising an electrical signal modulation device, via a bi-directional channel (e.g. an electromagnetic coupling or an electrical line connection with at least one of the coupling elements various signals, “multiple channels” can thus be transmitted, “modulated up”, to an electrical base signal. This type of coupling can (whether modulated up or not) be utilised in one direction or bi-directionally. Coils or galvanically conductive contacts are preferably used for purely electrical power transmission, i.e. not for signal transmission.

Peripheral units can, according to the invention, for example be exchangeable blocks or hoods for avoiding condensate, in particular of the type described at the beginning when discussing the prior art, and with the features described there. In its embodiment as a mixing device, the device according to the invention has a drive placed in the base unit (eccentric drive), which is driven by an electric motor. The eccentric drive is linked to a plate, which is, in the specialist jargon, also termed a “table”. The plate serves as a holding receptacle for a vessel block. Therefore, in particular the holder for placing an exchangeable block (one of the possible peripheral units) on the base unit is to be found on the plate. Consequently, the drive sets the plate, including the holder for the exchangeable block and the exchangeable block into a mixing motion. For a second possible peripheral unit, in particular a hood for avoiding condensate (hood), the holder is not located on the plate put into motion by the drive, but on an immoveable component of the device according to the invention.

Because such exchangeable blocks are mostly constructed in such a way that single vessels are inserted into them there from above, a circular translational recurrent mixing motion is preferred, which largely proceeds on a horizontal plane, and is also designated an orbital motion. For this purpose, preferably an eccentric drive, which is preferably driven by an electric motor, is responsible for putting a “table” (a holding device, onto which an exchangeable block can be placed) into such a circular motion. The device is then preferably driven with a rotational frequency of 200 rpm to 3,000 rpm, however rotational frequencies of 100 rpm to 10,000 rpm are also possible. The frequency is preferably adjustable.

Said at least one coupling preferably serves to supply at least one electric power consuming device, for example a heating or cooling device, but also, for instance, at least one sensor and/or at least one integrated circuit (IC) with energy through said at least one coupling of the peripheral unit and/or bring the peripheral unit into a signal connection with the base unit. Should power be supplied, the inductive coupling via a split pair coil is preferred, and/or the base unit and said at least one peripheral unit each have at least two (one) (additional) galvanic contact element(s), which, when the peripheral unit is placed on top of the base unit in the defined position, form at least one detachable conductive bifurcated contact, through which electric power can be transmitted from the base unit to an electric power consuming device in the peripheral unit.

With the device according to the invention, signals can be transmitted from the base unit to the peripheral unit and vice versa, from the peripheral unit to the base unit. Advantageously, operating restrictions for peripheral units can, for example, be stored in the peripheral units themselves (e.g. in EEPROMs), such as maximum rotational speeds or rotational speeds to be avoided (to be avoided because resonance frequencies threaten for the existing mass of a respective peripheral unit) and/or adjustment data for controlling the temperature. In regard to the previously known mixers, which work with temperature sensors inserted on the vessel block, which were attached to the base unit in a “dome”, this has the following advantages: The sensor system permanently installed in the peripheral unit, in particular in the exchangeable block, is less prone to interference and permits more accurate signal transmission, since it only belongs to one assembly; in particular, the sensor system permanently installed in the peripheral unit is closer to the sample—which is particularly important with large blocks—and there is no air space between the sensor system and the peripheral unit; this permits more accurate recording of the temperature, and thus more precise and more rapid adjustment. The sensor system permanently installed in the peripheral unit cannot be moved and/or shifted out of place; the sensor system permanently installed in the peripheral unit is easier to assemble; the sensor system permanently installed in the peripheral unit is a system ready for the future, for peripheral units to be newly developed, for example exchangeable blocks or other embodiments of the hood for avoiding condensate with additional benefits (lighting).

A temperature sensor that is preferably contained in the hood and/or the exchangeable block, as well as any memory chips for identifying the hood and/or the exchangeable block, can be inductively modulated up to the power supply or optically linked. A peripheral unit can also be detected using a magnet (preferably in the peripheral unit) and a magnetic sensor (Hall effect sensor, magneto resistor). Thus, according to the invention, supplying the coupling elements with energy and/or signals can be made dependent upon detecting the presence of a peripheral unit (and/or identifying it). In the case of inductive coupling elements, disconnecting the coil in the absence of a peripheral unit has the advantage that it cannot, as a “jamming transmitter”, influence other electronic devices in the environment. Electric power is preferably transmitted inductively at frequencies of 100-1000 kHz, particularly preferably at frequencies of 250-500 kHz. These frequency ranges have proven advantageous when optimising the overall size, the bridgeable air gap and the efficiency.

The retainer and said at least one peripheral unit may each have at least one positioning element, preferably designed as a plug connection element, which interact in the determined position as a positioning plug coupling—but also, in addition, as a transmission coupling according to the invention, for example if, according to the invention, coupling elements are integrated there. Magnetic, in particular ferromagnetic connecting elements can hold together the plug coupling (in addition, for example, to the combination of a force fit and a form fit of an additional spring-loaded locking mechanism, as well as in addition to the form fit of the plug connection) in the defined position. This, for instance, does justice to the requirement that an exchangeable block or a hood for avoiding condensate needs to be held securely, and may not fly away during the mixing motion. In comparison to the prior art mentioned at the beginning for fixing exchangeable blocks by screwing them down, solutions are to be preferred in the case of which a secure hold is automatically formed when the exchangeable block is placed, analogously on the electrical power and signal coupling. The latter could, for instance, be achieved using a locking mechanism or a spring element, in particular lateral pressure components.

The peripheral unit and/or the base unit may have a sliding cover, which can be slid into a position and is pre-stressed in this position by means of an elastic element. In the pre-stressed position, the sliding cover at least partially covers a coupling element. The latter in particular serves to provide additional protection for the coupling element. A coupling element may in any case be integrated flush very easily, and even behind a jointless housing surface, so that the sliding cover then constitutes additional protection.

The peripheral unit itself, in particular when designed as an exchangeable block with at least one coupling element and a sensor system, as well as when designed as a hood for avoiding condensate with at least one coupling element and a sensor system, is likewise according to the invention. Moreover, the use of the peripheral unit and/or the complete device according to the invention is also in accordance with the invention. Consequently, the features of the peripheral units according to the invention as described so far apply to both peripheral units as an element of the complete device and peripheral units on their own according to the invention.

Further advantages and features of the device according to the invention and peripheral units according to the invention are described, by way of example, with reference to the attached figures.

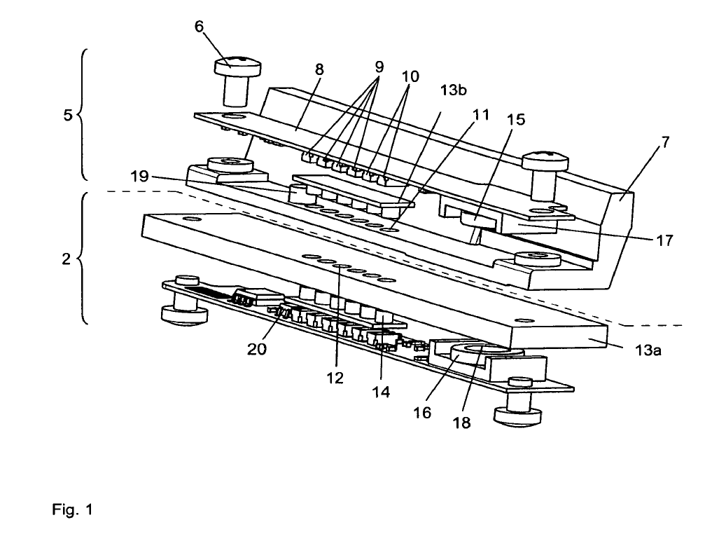

FIG. 1 shows a spatial view of couplings according to the invention.

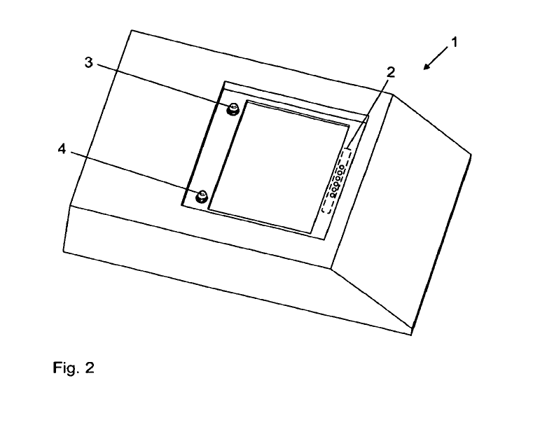

FIG. 2 shows a spatial top view onto a base unit according to the invention.

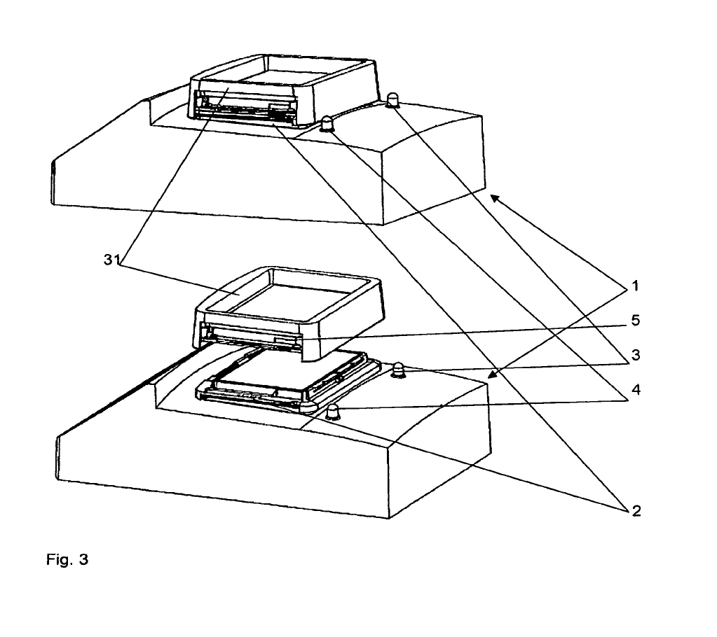

FIG. 3 shows two spatial lateral views of a base unit according to the invention, with a peripheral unit placed on it and removed, and the coupling of FIG. 2.

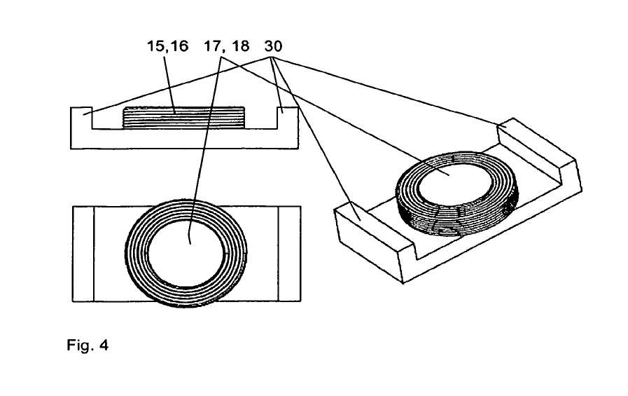

FIG. 4 shows a lateral view, a top view and a spatial lateral view of a coil with a core as an element of the coupling of FIG. 2.

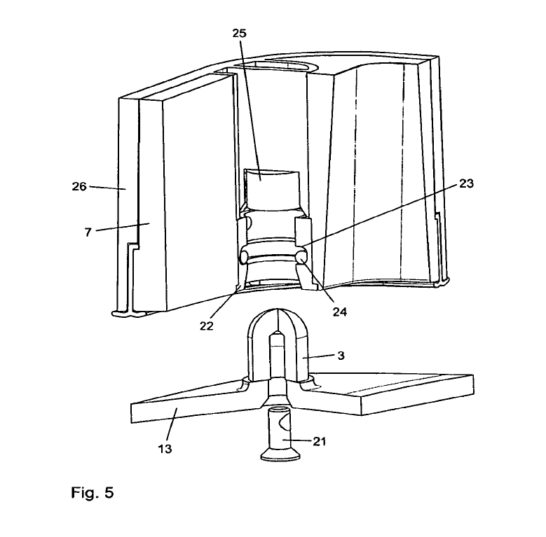

FIG. 5 shows a partially cropped spatial lateral view of an additional plug connection according to the invention.

FIG. 1 illustrates the scope of operation of an optical-inductive interface according to the invention. It consists of a Part 2 on the base unit side (see also FIG. 2) and a Part 5 on the peripheral unit side. The assembly on the peripheral unit side is fastened with screws 6 to an inner surface 7 of the peripheral unit, for example to the inner shell of a hood for avoiding condensate (the outer shell is not shown in this figure). A printed circuit board 8 houses six optical channels. Four channels transmit data from the hood for avoiding condensate to the base unit. Accordingly, four infra-red LEDs 9 can be found on the printed circuit board. Two channels transmit data from the base unit to the hood for avoiding condensate. For this purpose, two photoreceivers 10 are to be found on the printed circuit board. The optical components are, with their complementary coupling elements in the base unit, optically connected via apertures 11, 12 in the inner shell of the hood for avoiding condensate 7 and the top of the housing 13a of the base unit. As protection against contamination and ambient light, optical filters 13b, 14 are placed in the apertures 11, 12.

The power supply for two temperature sensors contained in the hood for avoiding condensate and an EEPROM (not shown here), as well as for the six optical channels, is implemented via an inductive coupling. For this purpose, respective coils 15, 16 are positioned on hoods for avoiding condensate and on the device side. These are respectively wound onto the central cones of a half-shell core 17, 18, and laterally have bars 30 for the targeted conducting of the magnetic field lines, the course of which, section by section, largely follows the course of field lines of the magnetic field (not shown) in order to improve the inductive signal transmission, in particular also via a gap or a housing—which can be easily discerned on the device side 18 based on a stylised illustration, and in detail in FIG. 4. Energy is transmitted in line with the principle of the loosely coupled transformer.

In addition, on the side of the hood for avoiding condensate there is a magnet 19. This is detected, on the device side, via a Hall effect sensor 20. Only once the hood for avoiding condensate is placed on top of the base unit in the defined (intended) position and the Hall effect sensor 20 recognises the magnets 19, is current applied to the coil 16. This way the power dissipation and the electromagnetic interference effect of the inductive interface are reduced.

The installation of the coupling assemblies 2 and 5 according to FIG. 1 in a base unit 1 and a peripheral unit 31 is shown schematically in FIG. 3.

FIG. 5 shows an additional magnetic electrical plug connection with a positioning mandrel or mandrel 3 (FIG. 2). An interface of identical construction is also implemented via the second positioning mandrel 4. The positioning mandrel 3 manufactured from a ferromagnetic metal is fastened to the top 13a of the base unit 1 using an electrically conductive screw 21. The screw 21 is connected to a power source (not shown here).

A metallic jack 22 is pressed into the inner shell 7 of the hood for avoiding condensate. The latter has an inner groove 23, into which an annular spring 24 is inserted. Should the hood for avoiding condensate be placed onto the base unit 1, an electrical conductive contact is produced from the positioning mandrel 3 via the annular spring 24 to the jack 22. Using a power cable (not shown here), this is then connected by means of a heating foil (not shown) into the hood for avoiding condensate. The electric circuit back to the base unit 1 is closed via the second interface through the positioning mandrel 4.

Besides the power conducting function described so far, the plug connection according to FIG. 5 has a holding function. For that purpose, a magnet 25 is pressed into the outer shell 26 of the hood for avoiding condensate. When the hood for avoiding condensate is placed on top of the base unit, the magnet exerts a magnetic force on the ferromagnetic positioning mandrel 3, and in this way in addition secures the hood on the base unit 1.

1. A device for controlling the temperature of laboratory vessels with
at least one vessel receptacle for receiving the laboratory vessels
at least one removably designed peripheral unit, and with
a base unit having a temperature control device and a mount for placing the at least one removable peripheral unit in a defined position, characterised in that the base unit and the at least one peripheral unit each have at least one coupling element, which, when the peripheral unit is placed on the base unit in the defined position, form at least one releasable coupled pair, through which electric power and/or at least one signal can be transmitted.

2. The device according to claim 1, characterised in that the respective coupling elements of the at least one releasable coupled pair are separated from one another galvanically.

3. The device according to claim 2, characterised in that, through said at least one releasable coupled pair optical and/or inductive and/or capacitive electric power coupled pair and/or at least one signal can be transmitted.

4. The device according to claim 1, characterised in that at least one respective coupling element in the base unit and the peripheral unit is a coil, and that both coils together, in the defined position, form said at least one releasable coupled pair.

5. The device according to claim 4, characterised in that electric power only flows through the coil in the base unit if a sensor which exists in the base unit detects the peripheral unit.

6. The device according to claim 5, characterised in that the electric power is transmitted via the coil in the base unit to the coil in the peripheral unit by means of frequencies in the range of 250 to 500 kHz.

7. The device according to claim 2, characterised in that said at least one coupling element in the base unit is an LED, in particular an infra-red LED, and said at least one coupling element in the peripheral unit is a photoreceiver, a photodiode, a phototransistor or a light-dependent resistor (LDR) or vice versa.

8. The device according to claim 1, characterised in that the peripheral unit has at least one sensor and/or at least one integrated circuit (C), wherein, through said at least one coupled pair, a signal can be transmitted by the sensor and/or the IC to the base unit, and/or from the base unit to the peripheral unit.

9. The device according to claim 2, characterised in that the base unit and said at least one peripheral unit each have at least one galvanic contact element, which, when the peripheral unit is placed on top of the base unit in the defined position, form at least one detachable conductive bifurcated contact, through which the electric power can be transmitted from the base unit to an electric power consuming device in the peripheral unit.

10. The device according to claim 1, characterised in that said at least one vessel receptacle is to be found in said at least one peripheral unit.

11. The device according to claim 10, characterised in that the peripheral unit is an exchangeable block.

12. The device according to claim 1, characterised in that said at least one peripheral unit is a hood, which, together with the walls of the base unit and/or the vessel block, encloses a space for laboratory vessels.

13. The device according to claim 1, characterised in that the base unit has at least one drive, through which said at least one vessel receptacle can be set into a mixing motion.

14. The device according to claim 1, characterised in that the holder on the base unit and said at least one peripheral unit each have a form-fit positioning element, and that said positioning elements together establish at least one degree of freedom of said at least one peripheral unit.

15. The device according to claim 14, characterised in that magnetic connecting elements, in particular ferromagnetic ones, together hold the positioning elements in the defined position.

16. The device according to claim 1, characterised in that the peripheral unit has a sliding cover, which can be slid into a position and, by means of an elastic element, is pre-stressed into this position, in which position the sliding cover covers at least one coupling element at least partially.

17. A peripheral unit for a device according to claim 1.

18. A use of the device according to claim 1 for biological, biochemical, molecular biological and/or chemical applications in the laboratory.

19. A method for manufacturing the device according to claim 1.
